(19) United States
(12) Patent Application Publication
(10) Pub. No.: US 2013/0114441 A1
(43) Pub. Date: May 9, 2013

(54) CHANNEL STATE INFORMATION COMPUTATION FOR ENHANCED INTER-CELL INTERFERENCE COORDINATION

(71) Applicants: Taesang Yoo, San Diego, CA (US); Xiliang Luo, Cardiff, CA (US); Tao Luo, San Diego, CA (US); Yongbin Wei, San Diego, CA (US)

(72) Inventors: Taesang Yoo, San Diego, CA (US); Xiliang Luo, Cardiff, CA (US); Tao Luo, San Diego, CA (US); Yongbin Wei, San Diego, CA (US)

(73) Assignee: QUALCOMM INCORPORATED, San Diego, CA (US)

(21) Appl. No.: 13/608,891

(22) Filed: Sep. 10, 2012

Related U.S. Application Data
(60) Provisional application No. 61/556,157, filed on Nov. 4, 2011.

(51) Int. Cl. H04W 24/00

(52) U.S. Cl. 370/252

(57) ABSTRACT

A delayed channel estimation is a channel state information (CSI) reference subframe having an index (N_{CSI}_{_{—}}_{ref}) belonging to N_{CSI}_{_{—}}_{ref}=N−4−k, where N is the subframe index on which the CSI is to be transmitted on an uplink, and k is the smallest value of k>=0, such that N−4−k belongs to a given configuration set. When k is too large, the selected CSI reference subframe is too outdated to produce accurate CSI. An undelayed channel estimation is a CSI reference subframe having an index (N_{CSI}_{_{—}}_{ref}) belonging to N_{CSI}_{_{—}}_{ref}=N−4. When the CSI reference subframe N−4 does not belong to the given subframe restriction subset, the selected channel estimate may be too noisy to produce accurate CSI. A method for CSI computation for enhanced inter-cell interference coordination (eICIC) selects between a delayed channel estimation and an undelayed channel estimation for computing CSI, for example, based on a signal metric. The CSI is computed with a selected channel estimation.

### CROSS-REFERENCE TO RELATED APPLICATION

The present application claims the benefit of U.S. Provisional Patent Application No. 61/556,157 filed on Nov. 4, 2011, in the names of T. Yoo et al., the disclosure of which is expressly incorporated by reference herein in its entirety.

### BACKGROUND

1. Field

Aspects of the present disclosure relate generally to wireless communication systems, and more particularly to channel state information (CSI) computation for enhanced inter-cell interference coordination (eICIC).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. As the demand for mobile broadband access continues to increase, however, there exists a need for further improvements in LTE technology. Preferably, these improvements should be applicable to other multi-access technologies and the telecommunication standards that employ these technologies.

### SUMMARY

Enhanced inter-cell interference coordination channel state information (CSI) reporting based on a common reference signal (CRS) interference coordination (CRS-IC) capability involves the selection of a CSI reference subframe. A delayed channel estimation refers to a CSI reference subframe that has an index (N_{CSI}_{_{—}}_{ref}) belonging to N_{CSI}_{_{—}}_{ref}=N−4−k, where N is the subframe index on which the CSI is to be transmitted on an uplink, and k is the smallest value of k>=0 chosen such that N−4−k belongs to a given configuration set. When k is too large, the selected CSI reference subframe for the channel estimation may be too outdated to produce accurate channel state information. An undelayed channel estimation refers to a CSI reference subframe that has an index (N_{CSI}_{_{—}}_{ref}) belonging to N_{CSI}_{_{—}}_{ref}=N−4. When the CSI reference subframe N−4 does not belong to the given subframe restriction subset, it may be subject to strong interference. In this scenario, the selected channel estimate may be too noisy to produce accurate channel state information.

According to one aspect of the present disclosure, a method for channel state information (CSI) computation for enhanced inter-cell interference coordination (eICIC) is described. The method includes selecting between a delayed channel estimation and an undelayed channel estimation for channel state information (CSI) computing, the selecting being based on a signal metric. The method also includes computing the CSI based on a selected channel estimation.

In another aspect, an apparatus for channel state information (CSI) computation for enhanced inter-cell interference coordination (eICIC) is described. The apparatus includes at least one processor; and a memory coupled to the at least one processor. The processor(s) is configured to select between a delayed channel estimation and an undelayed channel estimation for channel state information (CSI) computing, the selecting being based on a signal metric. The processor(s) is further configured to compute the CSI based on a selected channel estimation.

In a further aspect, a computer program product for channel state information (CSI) computation for enhanced inter-cell interference coordination (eICIC) is described. The computer program product includes a non-transitory computer-readable medium having program code recorded thereon. The computer program product has program code to select between a delayed channel estimation and an undelayed channel estimation for channel state information (CSI) computing. The selecting is based on a signal metric. The computer program product also has program code to compute the CSI based on a selected channel estimation.

In another aspect, an apparatus for channel state information (CSI) computation for enhanced inter-cell interference coordination (eICIC) is described. The apparatus includes means for selecting between a delayed channel estimation and an undelayed channel estimation for channel state information (CSI) computing. The selecting is based on a signal metric. The apparatus further includes means for computing the CSI based on a selected channel estimation.

According to yet another aspect of the present disclosure, a method for channel state information (CSI) computation for enhanced inter-cell interference coordination (eICIC) is described. The method includes maintaining a record of channel frequency responses (CFRs) for computing channel state information (CSI). The method also includes determining, for each subband, whether a criteria is met. The method further includes updating the record of CFRs over each subband that meet the criteria. The method also includes computing the CSI based on the record of CFRs.

In another aspect, an apparatus for channel state information (CSI) computation for enhanced inter-cell interference coordination (eICIC) is described. The apparatus includes at least one processor, and a memory coupled to the at least one processor. The processor(s) is configured to maintain a record of channel frequency responses (CFRs) for computing channel state information (CSI). The processor(s) is also configured to determine, for each subband, whether a criteria is met. The processor(s) is further configured to update the record of CFRs over each subband that meet the criteria. The processor(s) is also configured to compute the CSI based on the record of CFRs.

In a further aspect, a computer program product for channel state information (CSI) computation for enhanced inter-cell interference coordination (eICIC) is described. The computer program product includes a non-transitory computer-readable medium having program code recorded thereon. The computer program product has program code to maintain a record of channel frequency responses (CFRs) for computing channel state information (CSI). The computer program product also includes program code to determine, for each subband, whether a criteria is met. The computer program product further includes program code to update the record of CFRs over each subband that meet the criteria. The computer program product also includes program code to compute the CSI based on the record of CFRs.

In another aspect, an apparatus for channel state information (CSI) computation for enhanced inter-cell interference coordination (eICIC) is described. The apparatus includes means for maintaining a record of channel frequency responses (CFRs) for computing channel state information (CSI). The apparatus further includes means for determining, for each subband, whether a criteria is met. The apparatus also has means for updating the record of CFRs over each subband that meet the criteria. The apparatus also includes means for computing the CSI based on the record of CFRs.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of an access network.

FIG. 3 is a diagram illustrating an example of a downlink frame structure in LTE.

FIG. 4 is a diagram illustrating an example of an uplink frame structure in LTE.

FIG. 5 is a diagram illustrating an example of a radio protocol architecture for the user and control plane.

FIG. 6 is a diagram illustrating an example of an evolved Node B and user equipment in an access network.

FIG. 7 is a block diagram illustrating channel state information (CSI) reference subframe selection for channel state information computation to provide enhanced inter-cell interference coordination (eICIC) according to one aspect of the disclosure.

FIG. 8 is a flow chart illustrating a method for channel state information (CSI) computation for enhanced inter-cell interference coordination (eICIC) according to one aspect of the disclosure.

FIG. 9 is a flow chart illustrating a method for channel state information (CSI) computation for enhanced inter-cell interference coordination (eICIC) according to a further aspect of the disclosure.

FIG. 10 is a flow chart illustrating a method for channel state information (CSI) computation for enhanced inter-cell interference coordination (eICIC) according to a further aspect of the disclosure.

FIG. 11 is a flow chart illustrating a method for channel state information (CSI) computation for enhanced inter-cell interference coordination (eICIC) according to a further aspect of the disclosure.

FIG. 12 is a diagram illustrating an example of a hardware implementation for an apparatus employing a channel state information computing system according to one aspect of the disclosure.

FIGS. 13A and 13B are diagrams depicting the update of a channel frequency response (CFR) record for a frequency-domain partial loading scenario according to one aspect of the present disclosure.

FIGS. 14A-14C are diagrams depicting the update of a channel frequency response (CFR) record for a time-domain partial loading scenario according to one aspect of the present disclosure.

FIG. 15 illustrates a method for channel state information (CSI) computation for enhanced inter-cell interference coordination (eICIC) according to a further aspect of the disclosure.

FIG. 16 illustrates a method for updating of a channel frequency response (CFR) record for a frequency-domain partial loading scenario according to one aspect of the present disclosure.

FIG. 17 illustrates a method for updating of a channel frequency response (CFR) record for a time-domain partial loading scenario according to one aspect of the present disclosure.

FIG. 18 is a diagram illustrating an example of a hardware implementation for an apparatus employing a channel state information computing system according to one aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Aspects of the telecommunication systems are presented with reference to various apparatus and methods. These apparatus and methods are described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

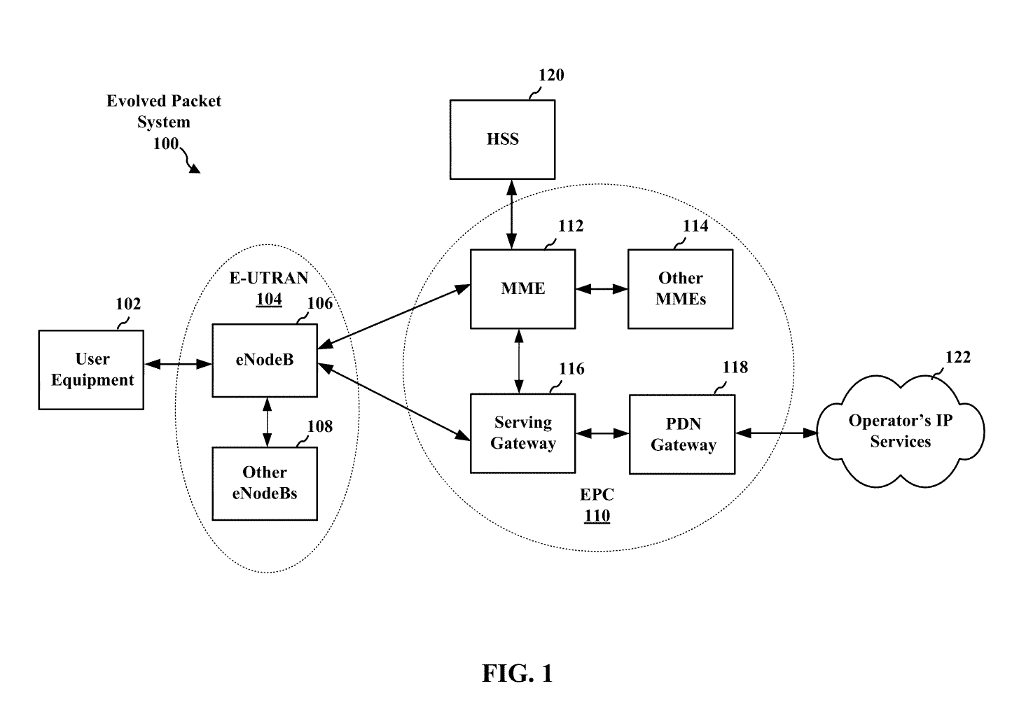

FIG. 1 is a diagram illustrating an LTE network architecture 100, which may be an LTE/-A network, in which channel state information (CSI) computation for enhanced inter-cell interference coordination (eICIC) may be performed, according to one aspect of the present disclosure. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an Si interface. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

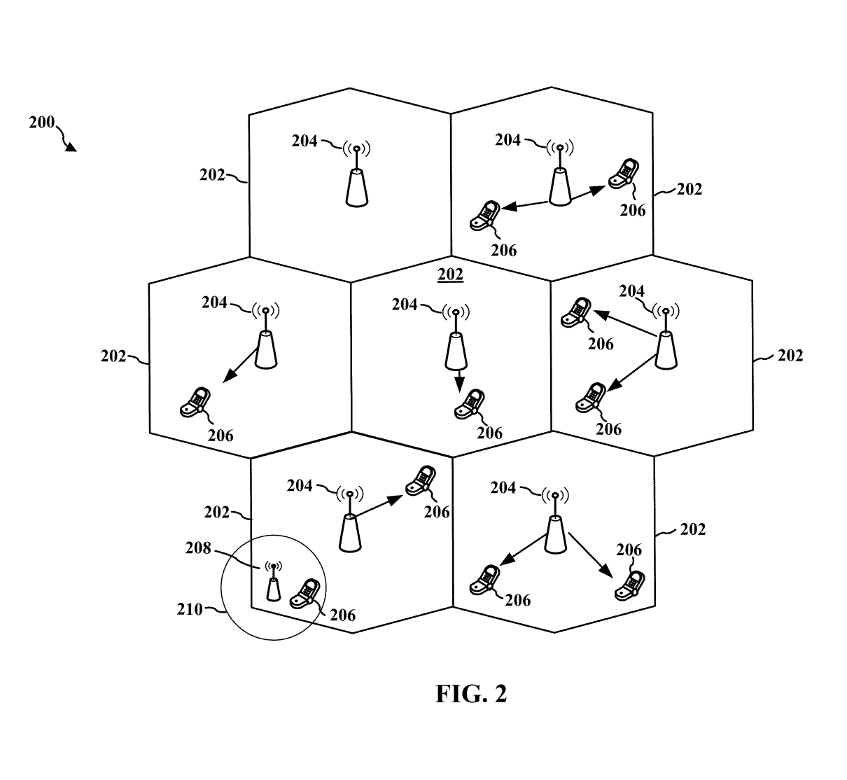

FIG. 2 is a diagram illustrating an example of an access network 200 in an LTE network architecture. In this example, the access network 200 is divided into a number of cellular regions (cells) 202. One or more lower power class eNodeBs 208 may have cellular regions 210 that overlap with one or more of the cells 202. The lower power class eNodeB 208 may be a remote radio head (RRH), a femto cell (e.g., home eNodeB (HeNodeB)), pico cell, or micro cell. The macro eNodeBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNodeBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the downlink and SC-FDMA is used on the uplink to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNodeBs 204 may have multiple antennas supporting MIMO technology. The use of MIMO technology enables the eNodeBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 206 with different spatial signatures, which enables each of the UE(s) 206 to recover the one or more data streams destined for that UE 206. On the uplink, each UE 206 transmits a spatially precoded data stream, which enables the eNodeB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PAPR).

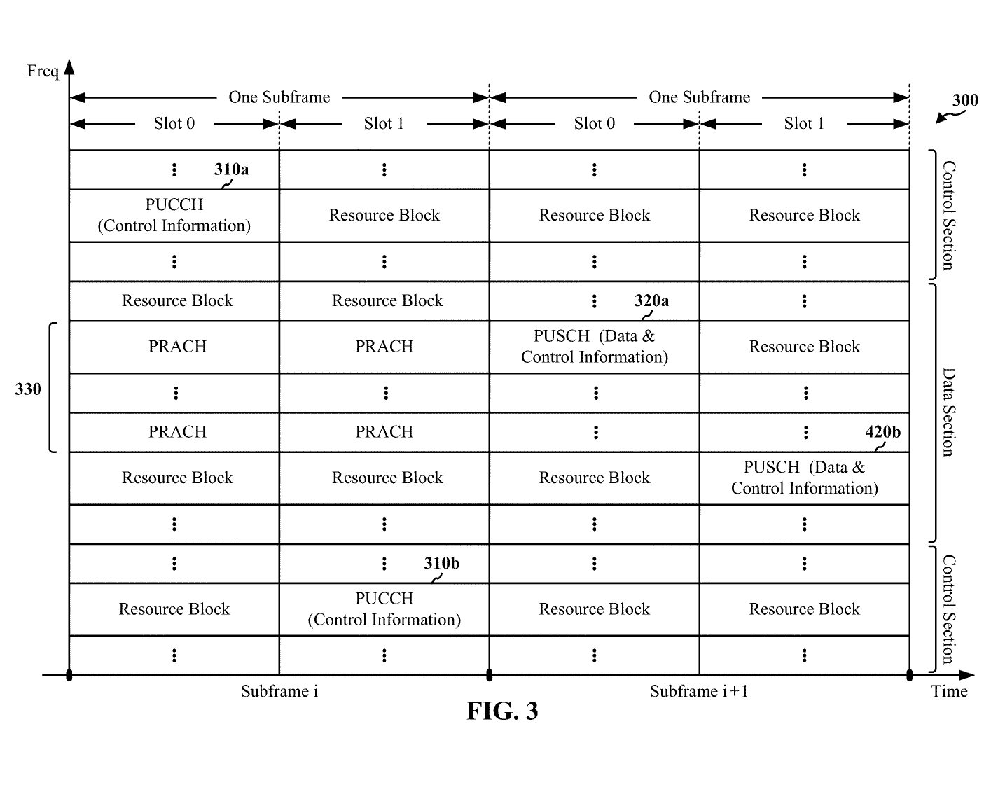

FIG. 3 is a diagram 300 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include downlink reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

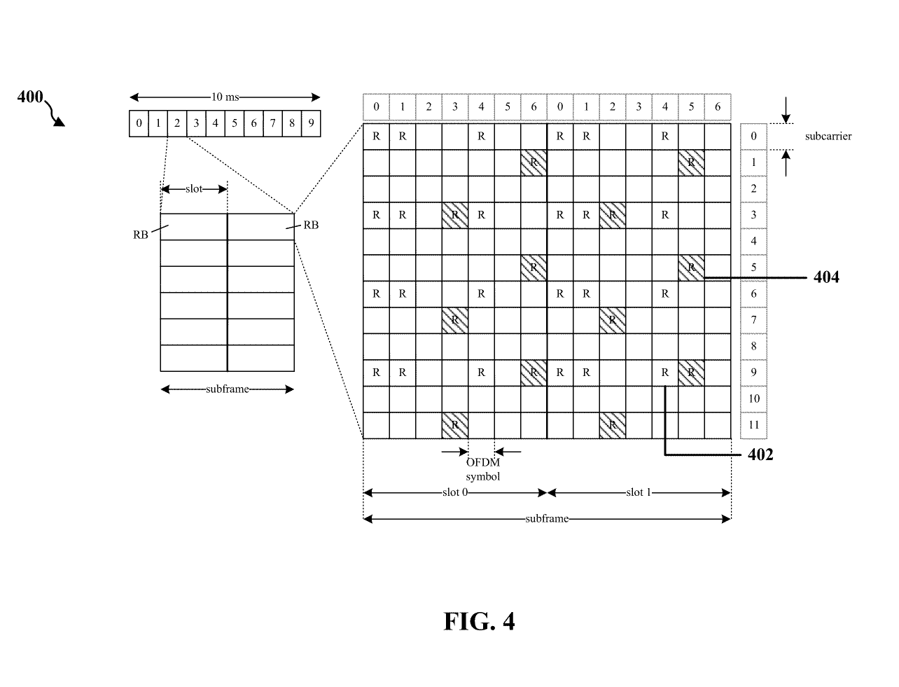

FIG. 4 is a diagram 400 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 410a, 410b in the control section to transmit control information to an eNodeB. The UE may also be assigned resource blocks 420a, 420b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 430. The PRACH 430 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

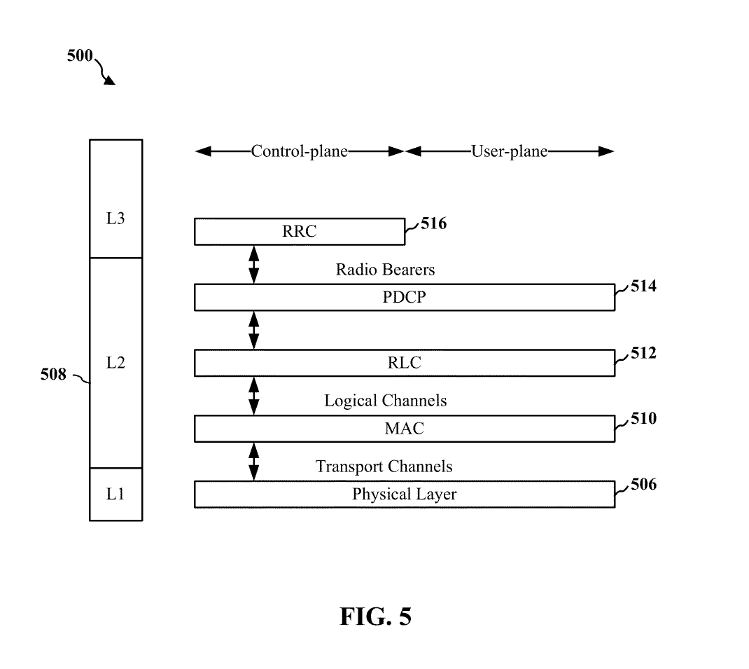

FIG. 5 is a diagram 500 illustrating an example of a radio protocol architecture for the user and control planes in LTE. The radio protocol architecture for the UE and the eNodeB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNodeB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNodeB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNodeBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNodeB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNodeB and the UE.

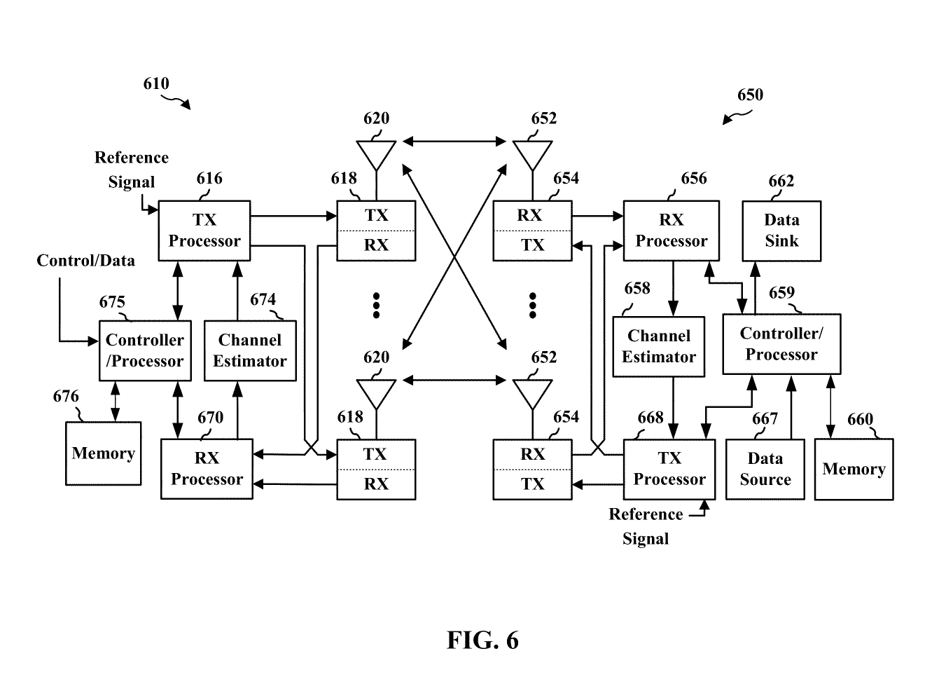

FIG. 6 is a block diagram of an eNodeB 610 in communication with a UE 650 in an access network. In the downlink, upper layer packets from the core network are provided to a controller/processor 675. The controller/processor 675 implements the functionality of the L2 layer. In the downlink, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618 TX. Each transmitter 618 TX modulates an RF carrier with a respective spatial stream for transmission.

At the UE 650, each receiver 654 RX receives a signal through its respective antenna 652. Each receiver 654 RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNodeB 610. These soft decisions may be based on channel estimates computed by the channel estimator 658. The soft decisions are then decoded and deinterleaved to recover the data and control signals that were originally transmitted by the eNodeB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the uplink, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the uplink, a data source 667 is used to provide upper layer packets to the controller/processor 659. The data source 667 represents all protocol layers above the L2 layer. Similar to the functionality described in connection with the downlink transmission by the eNodeB 610, the controller/processor 659 implements the L2 layer for the user plane and the control plane by providing header compression, ciphering, packet segmentation and reordering, and multiplexing between logical and transport channels based on radio resource allocations by the eNodeB 610. The controller/processor 659 is also responsible for HARQ operations, retransmission of lost packets, and signaling to the eNodeB 610.

Channel estimates derived by a channel estimator 658 from a reference signal or feedback transmitted by the eNodeB 610 may be used by the TX processor 668 to select the appropriate coding and modulation schemes, and to facilitate spatial processing. The spatial streams generated by the TX processor 668 are provided to different antenna 652 via separate transmitters 654 TX. Each transmitter 654 TX modulates an RF carrier with a respective spatial stream for transmission.

The uplink transmission is processed at the eNodeB 610 in a manner similar to that described in connection with the receiver function at the UE 650. Each receiver 618 RX receives a signal through its respective antenna 620. Each receiver 618 RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the uplink, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

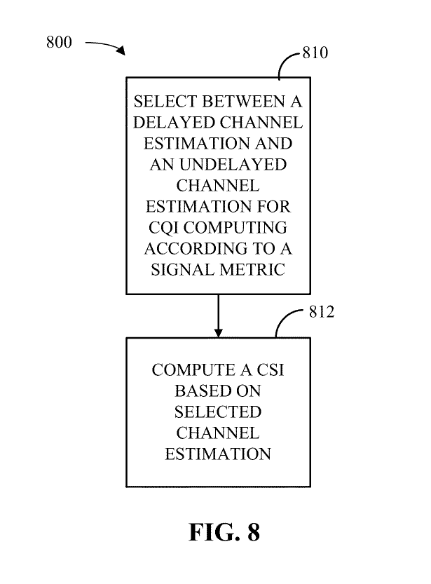

The controllers/processors 675 and 679 may direct the operation at the eNodeB 610 and the UE 650, respectively. The processor 675 and/or other processors and modules at the eNodeB 610 may perform or direct the execution of various processes for the techniques described herein. The processor 659 and/or other processors and modules at the UE 650 may also perform or direct the execution of the functional blocks illustrated in use in the method flow charts of FIGS. 8-11, and/or 15-17, and/or other processes for the techniques described involving channel state information (CSI) computation for enhanced inter-cell interference coordination (eICIC). The memories 676 and 660 may store data and program codes for the eNodeB 610 and the UE 650, respectively.

### Channel State Information Computation for Enhanced Inter-Cell Interference Coordination

Release eight (Release-8) of the long term evolution (LTE) standard specifies that channel state information (CSI) is reported during an uplink subframe N based on a CSI reference subframe. The CSI reference subframe is defined by a downlink subframe index (N_{CSI}_{_{—}}_{ref}). In a conventional FDD (frequency division duplexing) scenario, N_{CSI}_{_{—}}_{ref}=N−4. Release-8 of the LTE standard also specifies the measurement of channel estimation and interference (noise) estimation for CSI computation during the downlink subframe N_{CSI}_{_{—}}_{ref}. Further averaging across subframes is allowed to enhance the accuracy of the channel and interference estimates.

Release ten (Rel-10) of the long term evolution (LTE) standard specifies support for time domain enhanced inter-cell interference coordination (eICIC). In time domain eICIC, subframes are coordinated in time across different cells through backhaul signaling or an OAM (operations, administration and maintenance) configuration of almost blank subframe (ABS) patterns. Almost blank subframes are generally defined as subframes with reduced transmit power (including no transmission) and/or reduced activity on some physical channels.

Release 10 of LTE/-A provides support for enhanced inter-cell interference coordination by introducing subframe measurement restrictions. The subframe measurement restrictions are introduced so that CSI (channel state information) may be reported for different sets of subframes, such as regular subframes and almost blank subframes. The subframe measurement restrictions can be determined according to a csi-SubframePatternConfig-r10 parameter that specifies two subframe subsets: (1) C_{CSI,0}: csi-MeasSubframeSet1-r10; and (2) C_{CSL,1}: csi-MeasSubframeSet2-r10, in which C_{CSI,0} and C_{CSI,1} are not expected to overlap.

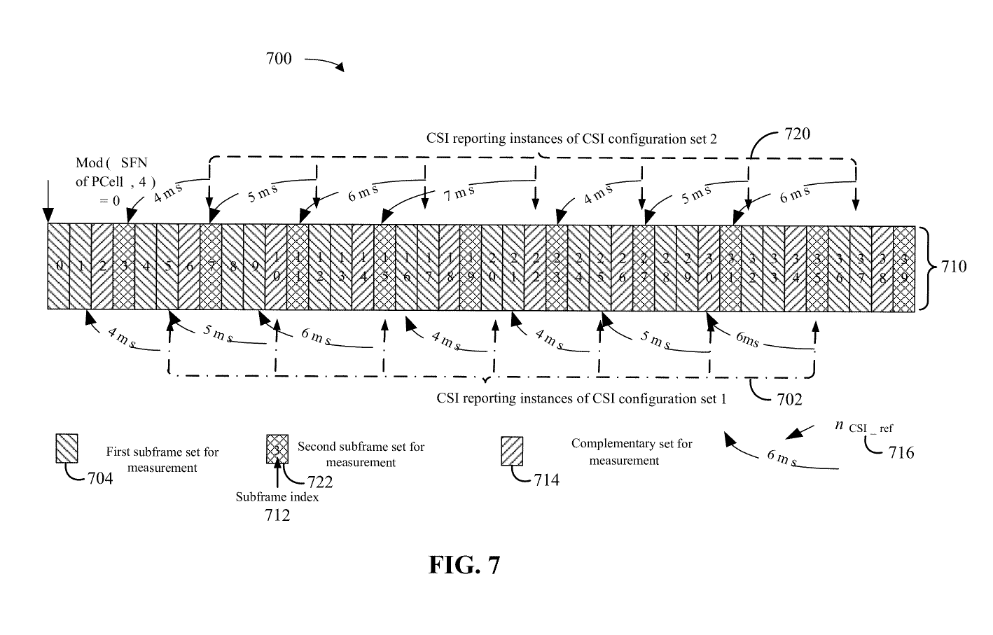

In operation, an eNodeB (e.g., eNodeB 610 of FIG. 6) configures either one or two sets of periodic reporting parameters:
Set 1: csi-pmi-ConfigIndex (periodicity/offset of CSI/PMI (channel state information/precoding matrix indicator(s))) & ri-ConfigIndex (periodicity/offset of RI (rank indicator)); and
Set 2: csi-pmi-ConfigIndex2 & ri-ConfigIndex2.
   For periodic CSI reporting for set n (n=1 or 2), interference may be measured within subframes belonging to C_{CSI,n}. That is, the CSI reference subframe defined according to a downlink subframe index N_{CSI}_{_{—}}_{ref} is changed, such that N_{CSI}_{_{—}}_{ref} belongs to C_{CSI,n}, for example, as illustrated in FIG. 7.

FIG. 7 is a block diagram 700 illustrating CSI reference subframe selection for channel state information computation to provide enhanced inter-cell interference coordination (eICIC) according to one aspect of the disclosure. Representatively, CSI reporting instances of a first CSI configuration set 702 and CSI reporting instances for a second CSI configuration set 720 are specified for subframes 710. In particular, a first set of subframes of the CSI reporting instances for the first CSI configuration set 702 are identified by a hatching pattern designated by reference number 704, a second set of subframes of CSI reporting instances for the second CSI configuration set 720 are identified by a cross hatching pattern designated by reference number 722, and a complementary set of subframes for measurement are identified by a hatching pattern designated by reference number 714.

As shown in FIG. 7, a CSI reference subframe for interference measurement (estimation) is selected when an index 712 corresponding to the CSI reference subframe (N_{CSI}_{_{—}}_{ref} 716) belongs to N_{CSI}_{_{—}}_{ref}=N−4−k, where N is the subframe index on which the CSI is to be transmitted on an uplink, and k is the smallest value of k>=0 chosen such that N−4−k belongs to the given configuration set 704/722. For example, the interference measurement at CSI reference subframe index 9 is used for a CSI reporting instance 702 of the first subframe set 704 at subframe index 15 (N=15) because subframe index 11 (N−4) is part of the second subframe set 722. Similarly, the interference measurement at CSI reference subframe index 7 is used for the CSI reporting instance of the second CSI configuration set 720 of the second subframe set 722 at subframe index 12 (N=12) because subframe index 8 (N−4) is part of the first subframe set 704.

While FIG. 7 illustrates the selection of a CSI reference subframe for interference estimation, the CSI reference subframe selected for channel estimation may be different. For a common reference signal (CRS) interference cancellation (CRS-IC) capable UE, the CSI reference subframe selected for channel estimation may be based on the presence or absence of a dominant, non-colliding CRS interferer. When a dominant non-colliding CRS interferer is absent, the channel can be measured on subframe index N−4, as the serving cell CRS (common reference signal) tones do not see interference other than from neighboring cells' CRS tones, which the UE can cancel out. When there is at least one dominant, non-colliding CRS interferer during the CSI reference subframe corresponding to index N−4, the serving cell CRS tones may see strong interference from neighboring cells' control and/or data transmission. In a non-CRS IC-capable UE, the serving cell CRS tones may also see strong interference from neighboring cells' CRS, control, and/or data transmission.

One aspect of the present disclosure describes a CSI reference subframe selection methodology for enhanced inter-cell interference cancellation CSI reporting based on a common reference signal (CRS) interference cancellation (CRS-IC) capability. In one configuration, a CRS-IC-capable UE selects a same CSI reference subframe for channel estimation and interference estimation. In particular, a CSI reference subframe is selected as N_{CSI}_{_{—}}_{ref}=N−4−k, where N is the subframe index on which the CSI is to be transmitted on an uplink, and k is the smallest value of k>=0 chosen such that N−4−k belongs to a given configuration set. The selected CSI reference subframe for the channel estimation in this configuration is referred to as “delayed channel estimation”. In the case where k is too large, the selected CSI reference subframe for the channel estimation may be too outdated to produce accurate channel state information. In this configuration, ‘k’ is selected as the smallest non-negative integer such that N−4−k belongs to the given subframe restriction subset, for example, as shown in FIG. 7.

In a further configuration, the CRS-IC-capable UE selects different CSI reference subframes for channel estimation and interference estimation. In particular, the index N_{CSI}_{_{—}}_{ref} of the CSI reference subframe for channel estimation is selected as N_{CSI}_{_{—}}_{ref}=N−4. The CSI reference subframe for channel estimation, in this configuration, may be referred to as “undelayed channel estimation”. When the CSI reference subframe N−4 does not belong to the given subframe restriction subset, it may be subject to strong interference. In this scenario, the selected channel estimate may be too noisy to produce accurate channel state information.

In one aspect of the disclosure, a CRS-IC-capable UE dynamically selects between a delayed channel estimation and an undelayed channel estimation according to a signal metric for computing channel state information (CSI). The signal metric may include, but is not limited to, the presence/absence of a non-colliding common reference signal interferer, an interferer power level, a channel estimation quality indication, and/or a Doppler level as observed at the user equipment (UE).

In one configuration, when the signal metric indicates the absence of a non-colliding CRS interferer, undelayed channel estimation is selected by the UE. For example, as shown in FIG. 7, subframe index 11 is selected as the undelayed channel estimation for the reporting instance at subframe index 15 because N−4=11, where N=15. In this example, the CSI reference subframe index 11 is the selected undelayed channel estimation although subframe index 11 is from the second subframe set 722. Conversely, the reporting instance at subframe index 15 belongs to the first CSI configuration set 702. That is, undelayed channel estimation for a reporting instance at subframe index N is selected solely according to the equation N−4 and does not vary according to the CSI configuration set of the selected subframe.

In a further aspect of the present disclosure, when the signal metric indicates the presence of a non-colliding CRS interferer, the UE selects between undelayed channel estimation and delayed channel estimation based on an interferer power level. The stronger the non-colliding CRS interferer power level, the greater the penalty of using the undelayed channel estimation. In this configuration, the UE selects the delayed channel estimation when the power level of the non-colliding RS interferer(s) exceeds a predetermined power level. For example, as shown in FIG. 7, subframe index 9 may be chosen for a delayed channel estimation for a CSI reporting instance 702 at subframe index 15 of the first subframe set 704. That is, the subframe index 9 is selected as a reference subframe for channel estimation because it belongs to the same CSI configuration set as the CSI reporting instance 702 at subframe index 15 and the power level of the interferer exceeds a threshold value.

In another configuration, when the signal metric indicates a channel estimation quality, the UE selects between undelayed channel estimation and delayed channel estimation based on the channel estimation quality. For example, when a channel estimation quality of the undelayed channel estimation is above a predetermined threshold, the undelayed channel estimation is selected for computing the channel state information. Otherwise, the UE selects the delayed channel estimation for computing the channel state information (e.g., a channel quality indicator (CQI)).

In a further configuration, the signal metric indicates a Doppler level as seen by the UE. When the signal metric indicates a Doppler level, the UE selects between undelayed channel estimation and delayed channel estimation based on the Doppler level. A high Doppler level results in a greater penalty for using the delayed channel estimation. In this configuration, when the Doppler level is above a predetermined threshold, the undelayed channel estimation is selected for computing the channel quality indicator. Otherwise, the UE may select the delayed channel estimation for computing the channel quality indicator based on other signal metrics.

FIG. 8 illustrates a method 800 for channel state information (CSI) computation for enhanced inter-cell interference coordination (eICIC) according to one aspect of the disclosure. In block 810, the CSI computation for eICIC includes selecting between delayed channel estimation and undelayed channel estimation for computing channel quality information according to a signal metric. For example, as shown in FIG. 7, subframe index 11, although belonging to the second subframe set 722, is the undelayed channel estimation selected for the reporting instance at subframe index 15. The reporting instance at subframe index 15, however, belongs to the first CSI configuration set 702.

As further shown in FIG. 7, subframe index 9 may be chosen for a delayed channel estimation for a reporting instance at subframe index 15 of the first CSI configuration set 702. In this configuration, the CSI computation for eICIC selects between the subframe index 11 (undelayed channel estimation) and the subframe index 9 (delayed channel estimation) based on a signal metric. The signal metric may include, but is not limited to, the presence/absence of a non-colliding reference signal interferer, an interferer power level, a channel estimation quality indication, a Doppler level, as observed at the user equipment (UE), or other like signal metric. In block 812, the UE computes a channel state information (CSI) based on the selected channel estimation.

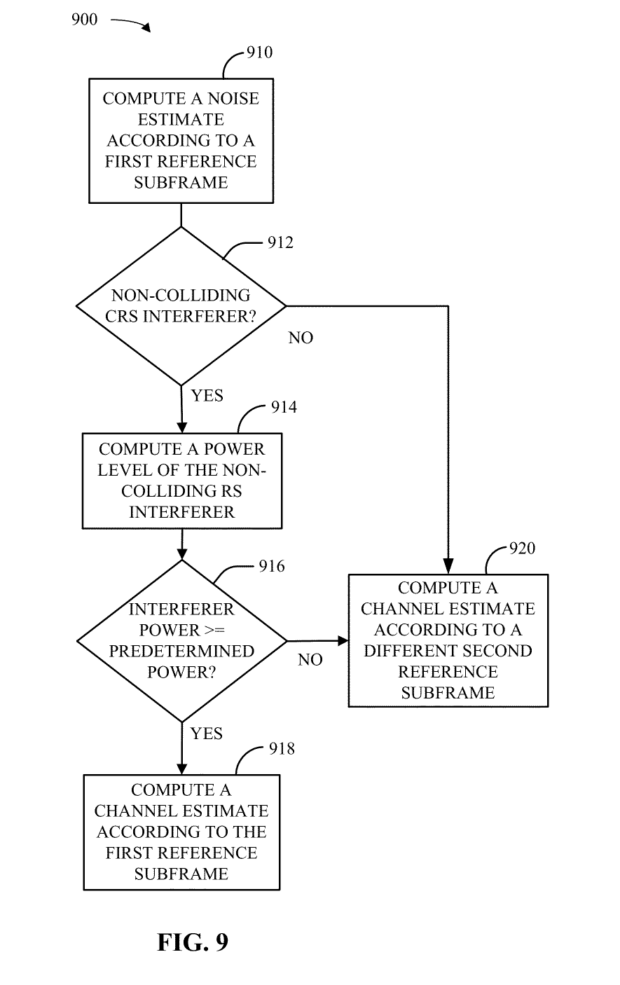

FIG. 9 illustrates a method 900 for CSI computation for enhanced inter-cell interference coordination (eICIC) according to a further aspect of the disclosure. At block 910, a noise estimate is computed according to a first reference subframe. For example, as shown in FIG. 7, a CSI reference subframe for interference (noise) measurement (estimation) is selected when an index 712 corresponding to the CSI reference subframe (N_{CSI}_{_{—}}_{ref} 716) belongs to N_{CSI}_{_{—}}_{ref}=N−4−k, where N is an index of a current subframe and k>=0 is chosen such that N−4−k belongs to the given configuration set 704/722. In this example, the interference measurement at CSI reference subframe index 9 is used for a CSI reporting instance 702 at subframe index 15 (N=15) because subframe index 11 (N−4) is part of the second subframe set 722.

Referring again to FIG. 9, in this aspect of the disclosure, the signal metric indicates the presence or absence of a non-colliding interferer at block 912. When the signal metric indicates the absence of a non-colliding reference signal (RS) interferer, undelayed channel estimation is selected by the UE at block 920. For example, as shown in FIG. 7, subframe index 11 is selected as the undelayed channel estimation for the reporting instance at subframe index 15 because N−4=11, where N=15.

In this example, the CSI reference subframe index 11 is the selected undelayed channel estimation although subframe index 11 is from the second subframe set 722. Conversely, the reporting instance at subframe index 15 is for the first CSI configuration set 702. That is, undelayed channel estimation for a reporting instance at subframe index N is selected solely according to the equation N−4 and does not vary according to the measurement subframe set of the selected subframe. As a result, the second reference subframe selected for channel estimation at block 920 is different from the first reference subframe selected for noise estimation at block 910.

When the signal metric indicates the presence of a non-colliding reference signal (RS) interferer, a power level of the RS interferer is computed at block 914. When it is determined that the interferer power level is greater than or equal to a predetermined power level at block 916, at block 918, the channel estimate is computed according to the same first reference subframe as in block 910. Otherwise, the channel estimate is computed according to the different second reference subframe as shown in block 920. For example, as shown in FIG. 7, subframe index 9 belongs to the first subframe set 704, but is the delayed channel estimation selected for the reporting instance at subframe index 15. In this configuration, subframe index 9 is selected for both noise estimation at block 910 and channel estimation at block 918 because the interferer power level is above the predetermined power level.

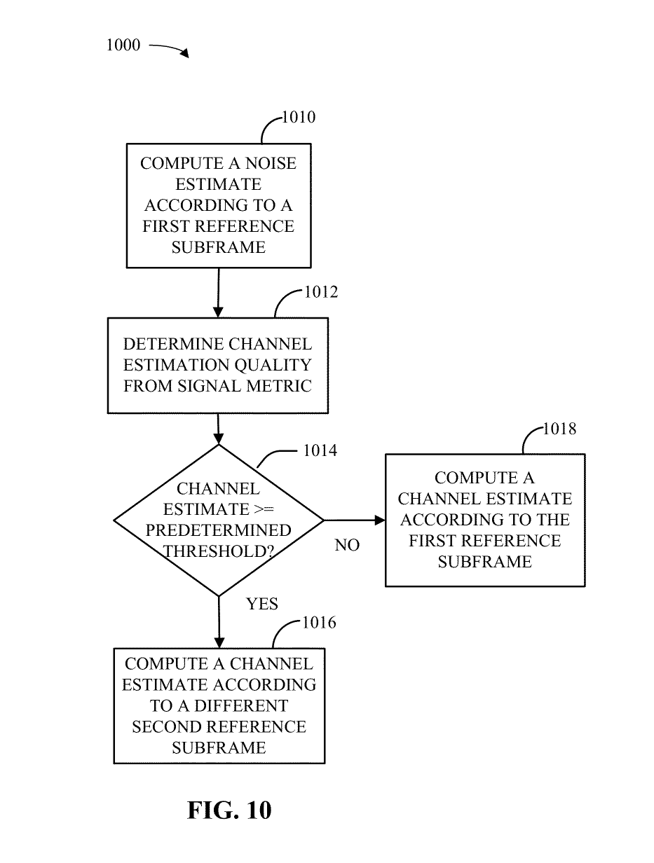

FIG. 10 illustrates a method 1000 for CSI computation for enhanced inter-cell interference cancellation (eICIC) according to a further aspect of the disclosure. At block 1010, a noise estimate is computed according to a first reference subframe. For example, as shown in FIG. 7, the interference measurement at CSI reference subframe index 9 is used for a CSI reporting instance 702 at subframe index 15 (N=15) because subframe index 11 (N−4) and subframe index 10 (N−5) are not part of the first subframe set 704.

In the aspect of the present disclosure shown in FIG. 10, the signal metric indicates a channel estimation quality. Accordingly, at block 1012, a channel estimation quality is determined from the signal metric. In this aspect of the disclosure, the UE selects between undelayed channel estimation (second reference subframe) and delayed channel estimation (first reference subframe) based on the channel estimation quality. For example, when a channel estimation quality of the undelayed channel estimation is above a predetermined threshold at block 1014, the undelayed channel estimation (second reference subframe) is selected for computing the channel state information at block 1016. Otherwise, at block 1018, the UE selects the delayed channel estimation (first reference subframe) for computing the channel state information (e.g., a channel quality indicator).

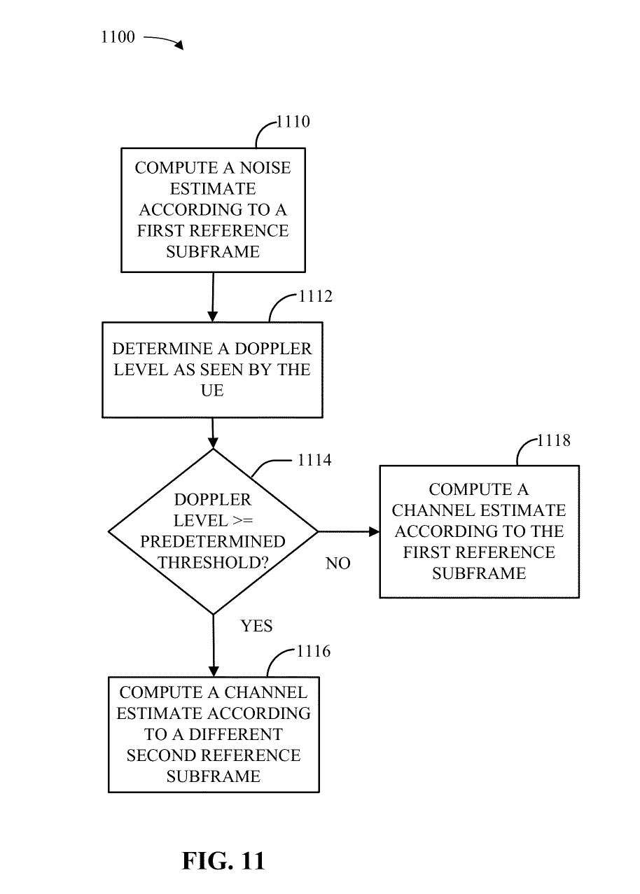

FIG. 11 illustrates a method 1100 for CSI computation for enhanced inter-cell interference coordination (eICIC) according to a further aspect of the disclosure. At block 1110, a noise estimate is computed according to a first reference subframe. For example, as shown in FIG. 7, the interference measurement at CSI reference subframe index 9 is used for a CSI reporting instance 702 at subframe index 15 (N=15) because both subframe index 11 (N−4) and subframe index 10 (N−5) are not part of the first subframe set 704.

In this aspect of the disclosure, the signal metric indicates a Doppler level as seen by the UE. Accordingly, at block 1112, a Doppler level is determined by the UE. In this aspect of the disclosure, the UE selects between undelayed channel estimation and delayed channel estimation based on the Doppler level. A higher Doppler level results in a greater penalty for using the delayed channel estimation. In this configuration, when the Doppler level is above a predetermined threshold at block 1114, the undelayed channel estimation (second reference subframe) is selected for computing the channel quality indicator at block 1116. Otherwise, at block 1118 the UE selects the delayed channel estimation (first reference subframe) for computing the channel estimate.

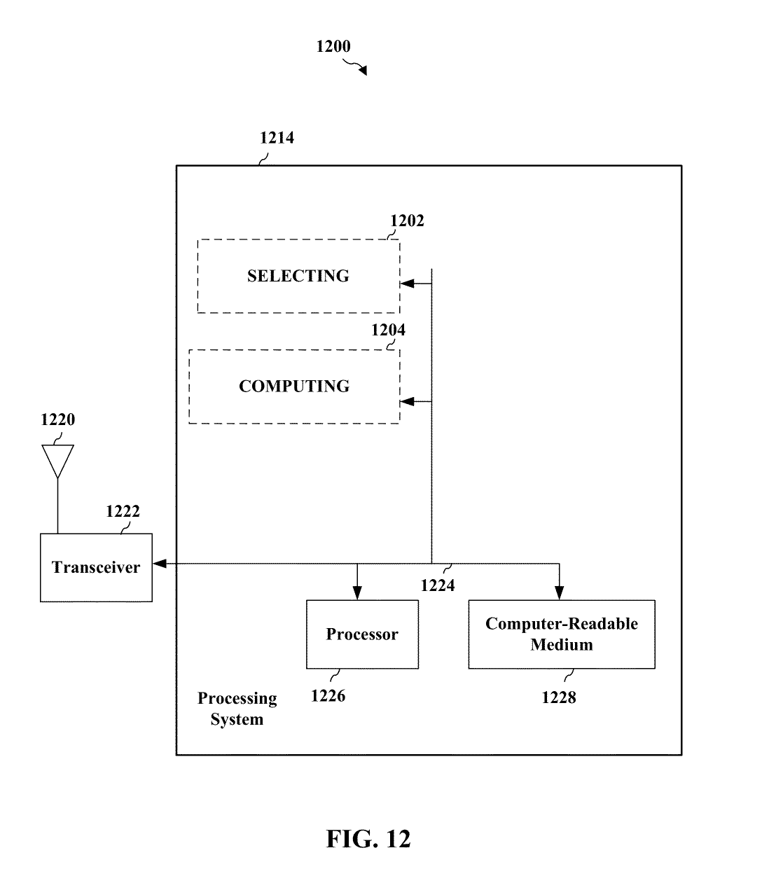

FIG. 12 is a diagram illustrating an example of a hardware implementation for an apparatus 1200 employing a channel state information computing system 1214 according to one aspect of the disclosure. The channel state information computing system 1214 may be implemented with a bus architecture, represented generally by a bus 1224. The bus 1224 may include any number of interconnecting buses and bridges depending on the specific application of the channel state information computing 1214 and the overall design constraints. The bus 1224 links together various circuits including one or more processors and/or hardware modules, represented by a processor 1226, a selecting module 1202, a computing module 1204, and a computer-readable medium 1228. The bus 1224 may also link various other circuits such as timing sources, peripherals, voltage regulators, and power management circuits, which are well known in the art, and therefore, will not be described any further.

The apparatus includes the channel state information computing system 1214 coupled to a transceiver 1222. The transceiver 1222 is coupled to one or more antennas 1220. The transceiver 1222 communicates with various other apparatus over a transmission medium. The channel state information computing system 1214 includes the processor 1226 coupled to the computer-readable medium 1228. The processor 1226 is responsible for general processing, including the execution of software stored on the computer-readable medium 1228. The software, when executed by the processor 1226, causes the channel state information computing system 1214 to perform the various functions described supra for any particular apparatus. The computer-readable medium 1228 may also be used for storing data that is manipulated by the processor 1226 when executing software.

The channel state information computing system 1214 further includes the selecting module 1202 for selecting between delayed channel estimation and undelayed channel estimation for channel state information (CSI) computing according to a signal metric. The selecting module 1202 receives the channel estimates from the processor 1226. The channel state information computing system 1214 also has a computing module 1204 that computes a CSI based on selected channel estimation. The computing module receives the selection from the selecting module 1202. The selecting module 1202 and the computing module 1204 may be software modules running in the processor 1226, resident/stored in the computer-readable medium 1228, one or more hardware modules coupled to the processor 1226, or some combination thereof. The channel state information computing system 1214 may be a component of the UE 650 and may include the memory 660 and/or the controller/processor 659, for example, as shown in FIG. 6.

In one configuration, the apparatus 1200 for wireless communication includes means for selecting. The selecting means may be the selecting module 1202 and/or the channel state information computing system 1214 of the apparatus 1200 configured to perform the functions recited by the selecting means. As described above, the selecting means may include the controller/processor 659, and/or the memory 660 of the UE 650 shown in FIG. 6. In another aspect of the disclosure, the selecting means may be any module or any apparatus configured to perform the functions recited by the selecting means.

In one configuration, the apparatus 1200 for wireless communication also includes means for computing. The computing means may be the computing module 1204 and/or the channel state information computing system 1214 of the apparatus 1200 configured to perform the functions recited by the computing means. As described above, the computing means may include the controller/processor 659, and/or the memory 660 of the UE 650. In another aspect of the disclosure, the computing means may be any module or any apparatus configured to perform the functions recited by the computing means.

In a further aspect of the present disclosure, a UE maintains a record of the channel frequency response (CFR) for computing channel quality for a set of resources. In this aspect of the disclosure, the record of channel frequency response is updated over a subset of resources according to a criteria. The set of resources may include frequencies, time domain resources, or other like resources. For example, the CFR record may be updated over particular frequency tones whenever the UE believes the estimation quality over those tones meets some pre-determined criteria. In addition, the CFR record may not cover all frequency tones for the purpose of CSI feedback. For example, the CFR record may keep one out of every six tones. The criteria may include, but is not limited to, a signal-to-interference plus noise ratio (SINR) over a portion of the set of frequencies, a channel Doppler speed, a mean square estimation error of a current channel estimate, or other like channel criteria.

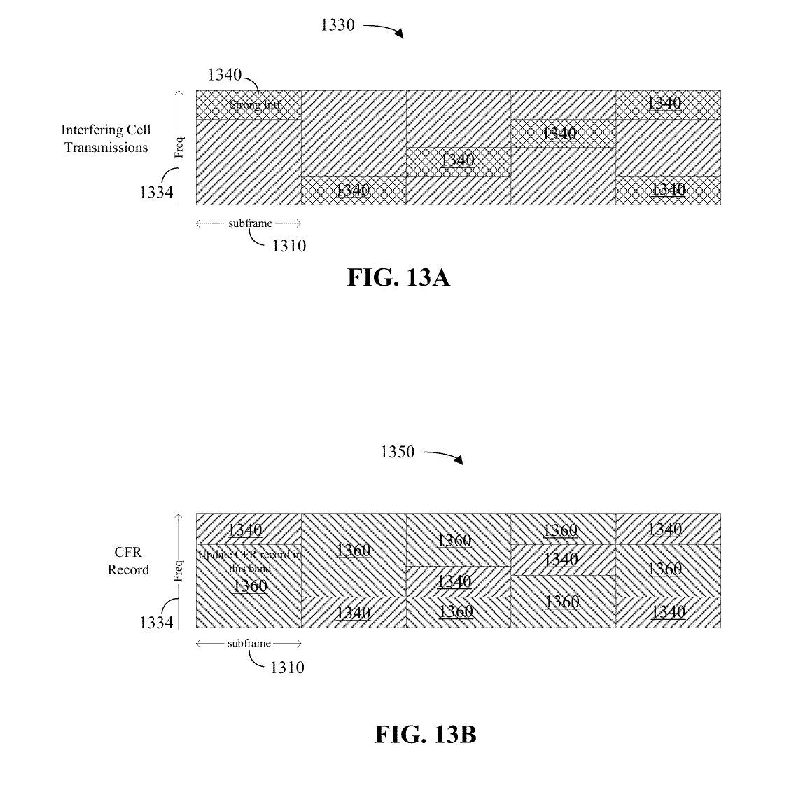

FIGS. 13A and 13B are diagrams 1330 and 1350 depicting the update of a channel frequency response (CFR) record for a frequency-domain partial loading scenario according to one aspect of the present disclosure. FIG. 13A illustrates frequencies 1334 within subframes 1310 in which interfering cell transmissions occur. Representatively, strong interference 1340 occurs during various portions of the subframes 1310 shown in FIG. 13A. FIG. 13B illustrates frequencies 1334 within subframes 1310 in which a channel frequency response record is updated. Representatively, strong interference 1340 occurs during various portions of the subframes 1310 shown in FIG. 13B. In this aspect of the disclosure, updating of the CFR is performed within frequency bands 1360 where the interference level is low such that the SINR (signal interference to noise ratio) (or some other channel metric) over that band exceeds a predetermined threshold value.

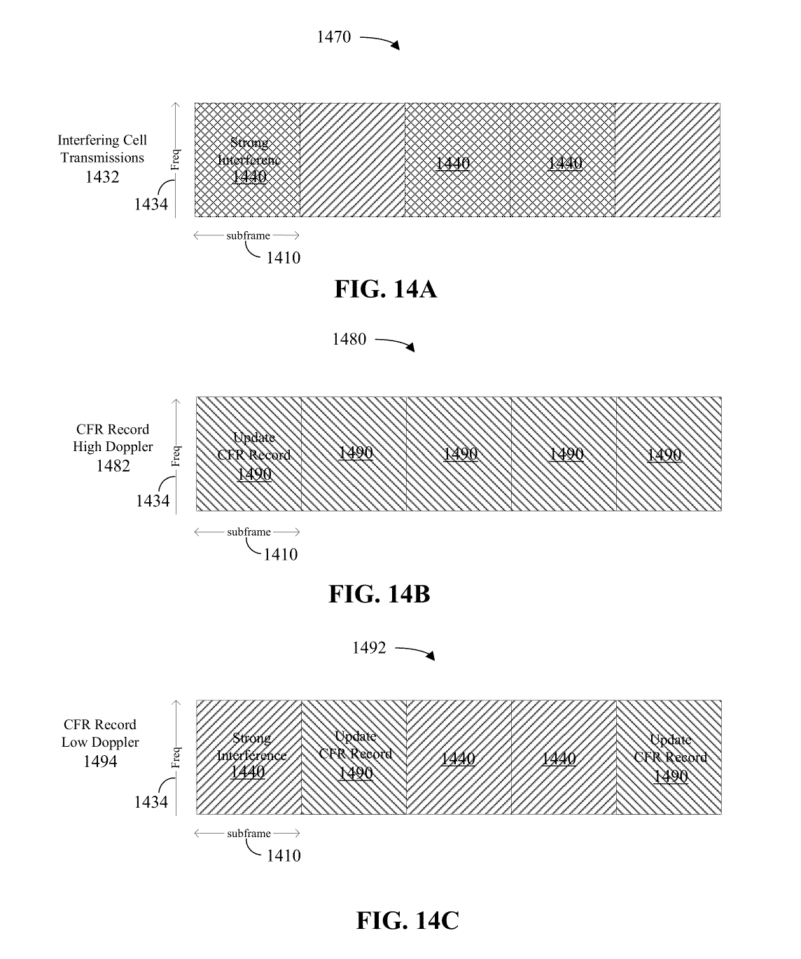

FIGS. 14A to 14C are diagrams 1470, 1480, and 1492 depicting the update of a channel frequency response (CFR) record for a time-domain partial loading scenario according to one aspect of the present disclosure. FIG. 14A illustrates frequencies 1434 within subframes 1410 in which interfering cell transmissions 1432 occur. Representatively, strong interference 1440 occurs during various subframes 1410 shown in FIG. 14A. FIG. 14B illustrates subframes 1490 in which a channel frequency response record is updated under high Doppler conditions 1482. That is, the CFR is updated at every subframe in high Doppler conditions.

FIG. 14C illustrates subframes 1410 in which a channel frequency response record is updated under low Doppler conditions 1494. Representatively, strong interference 1440 occurs during various subframes 1410 shown in FIG. 14C. In this aspect of the disclosure, updating of the CFR record is performed within subframes 1490 where the channel estimate is believed to be good, e.g., the MSE (mean square error) of the current channel estimation is lower than a predetermined threshold value. In this aspect of the disclosure, depending on the interference level, which changes from subframe to subframe, the CFR record is updated with the most recent channel estimation depending on the quality of the current channel estimation.

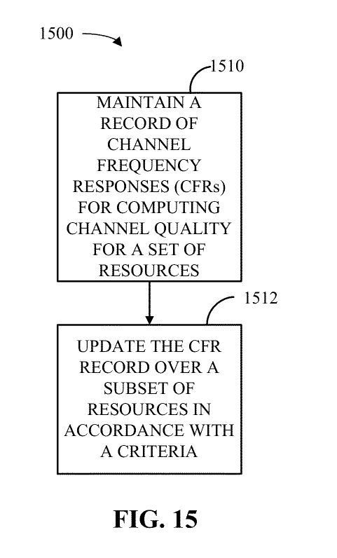

FIG. 15 illustrates a method 1500 for channel state information (CSI) computation for enhanced inter-cell interference coordination (eICIC) according to a further aspect of the disclosure. In block 1510, a UE maintains a record of channel frequency responses (CFRs) for computing channel quality for a set of resources. In block 1512, the UE updates the CFR record over a subset of resources in accordance with a criteria. In this configuration, the criteria may include but is not limited to a signal-to-interference plus noise ratio (SINR) over a portion of the subset of resources together with a channel Doppler speed, a mean square estimation error of a current channel estimation, and the like, as observed by the UE. In this configuration, the subset of resources includes either frequencies having a channel quality exceeding a threshold value during a frequency domain partial loading scenario (e.g., FIGS. 13A and 13B) or subframes having a means square error of the current channel estimation below a threshold value during a time domain partial loading scenario (e.g., FIGS. 14A to 14C).

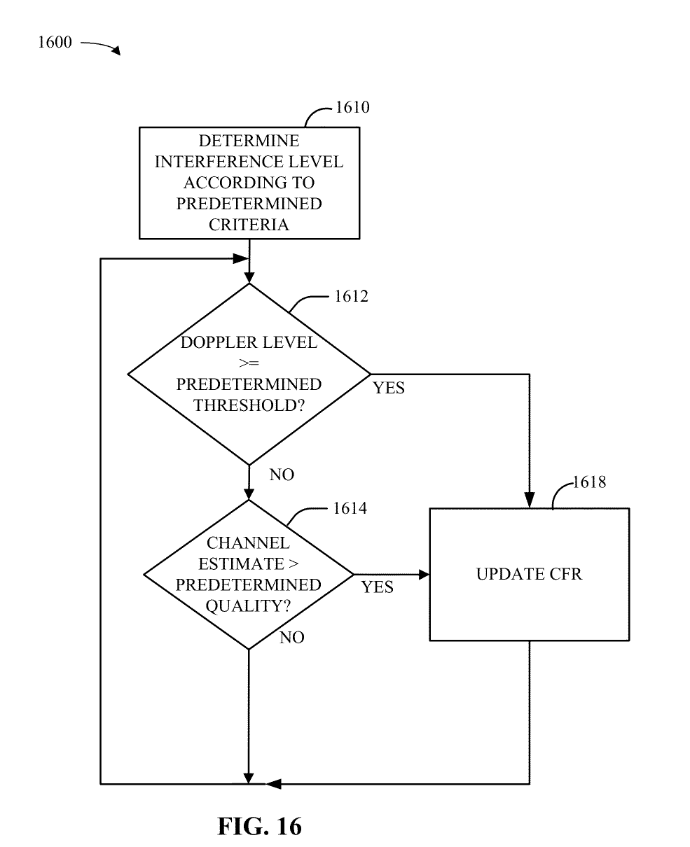

FIG. 16 illustrates a method 1600 for updating a channel frequency response (CFR) record for a time-domain partial loading scenario according to one aspect of the present disclosure. At block 1610, a channel estimate and a Doppler level are determined for a subframe.

When the Doppler level is above a predetermined threshold (block 1612), the CFR is updated for that subframe at block 1618. At block 1614 it is determined if a channel estimate is above a certain quality. If so, at block 1618 the CFR is updated. Otherwise (and also after the CFR has been updated at block 1618), the process returns to block 1610 for processing of the next time period (e.g., subframe).

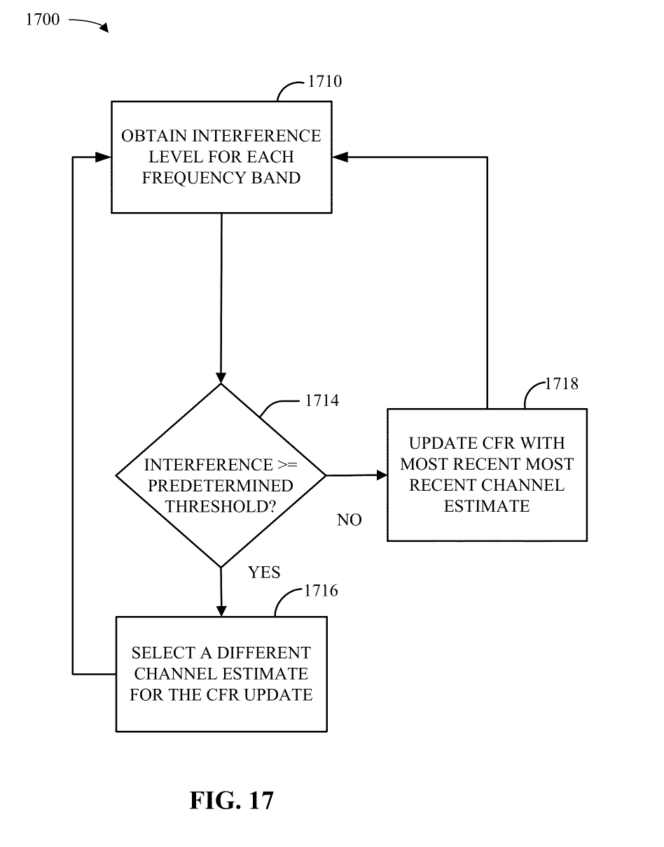

FIG. 17 illustrates a method 1700 for updating of a channel frequency response (CFR) record for a frequency-domain partial loading scenario according to one aspect of the present disclosure. At block 1710, an interference level is determined for each frequency band during a first time period (e.g., subframe). When the interference level is above a threshold value (block 1714), at block 1716, the CFR is not updated for that frequency band. For example, FIG. 13B illustrates a frequency band with strong interference 1340 in which a channel frequency response record is not updated. If the interference level for a frequency band is below the threshold value, the CFR record is updated with the most recent channel estimation at block 1718. For example, FIG. 13B shows frequency bands 1360 that are updated. After blocks 1716 and 1718, the process returns to block 1710 to evaluate the next interference in the next time period.

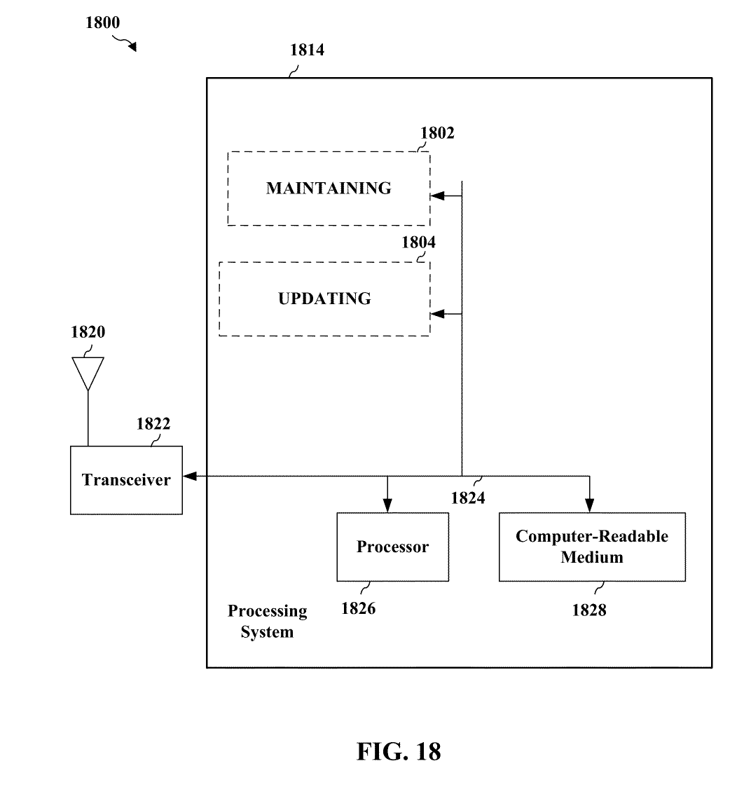

FIG. 18 is a diagram illustrating an example of a hardware implementation for an apparatus 1800 employing a channel state information computing system 1814 according to one aspect of the disclosure. The channel state information computing system 1814 may be implemented with a bus architecture, represented generally by a bus 1824. The bus 1824 may include any number of interconnecting buses and bridges depending on the specific application of the channel state information computing system 1814 and the overall design constraints. The bus 1824 links together various circuits including one or more processors and/or hardware modules, represented by a processor 1826, a maintaining module 1802, an updating module 1804, and a computer-readable medium 1828. The bus 1824 may also link various other circuits such as timing sources, peripherals, voltage regulators, and power management circuits, which are well known in the art, and therefore, will not be described any further.

The apparatus 1800 includes the channel state information computing system 1814 coupled to a transceiver 1822. The transceiver 1822 is coupled to one or more antennas 1820. The transceiver 1822 communicates with various other apparatus over a transmission medium. The channel state information computing system 1814 includes the processor 1826 coupled to the computer-readable medium 1828. The processor 1826 is responsible for general processing, including the execution of software stored on the computer-readable medium 1828. The software, when executed by the processor 1826, causes the channel state information computing system 1814 to perform the various functions described supra for any particular apparatus. The computer-readable medium 1828 may also be used for storing data that is manipulated by the processor 1826 when executing software.

The channel state information computing system 1814 further includes a maintaining module 1802 that maintains a record of channel frequency responses (CFRs) for computing channel quality for a set of resources. The maintaining module 1802 receives the CFRs from the processor 1826. The channel state information computing system 1814 also includes an updating module 1804 that updates the record of CFRs over a subset of resources according to a criteria. The updating module 1804 forwards the updates to the maintaining module 1802. The maintaining module 1802 and the updating module 1804 may be software modules running in the processor 1826, resident/stored in the computer-readable medium 1828, one or more hardware modules coupled to the processor 1826, or some combination thereof. The channel state information computing system 1814 may be a component of the UE 650 and may include the memory 660 and/or the controller/processor 659, for example, as shown in FIG. 6.

In one configuration, the apparatus 1800 for wireless communication includes means for maintaining. The maintaining means may be the maintaining module 1802 and/or the channel state information computing system 1814 of the apparatus 1800 configured to perform the functions recited by the maintaining means. As described above, the maintaining means may include the controller/processor 659, and/or memory 660 of the UE 650 shown in FIG. 6. In another aspect, the maintaining means may be any module or any apparatus configured to perform the functions recited by the maintaining means.

In one configuration, the apparatus 1800 for wireless communication includes means for updating. The updating means may be the updating module 1804 and/or the channel state information computing system 1814 of the apparatus 1800 configured to perform the functions recited by the updating means. As described above, the updating means may include the controller/processor 659, and/or memory 660 of the UE 650 shown in FIG. 6. In another aspect, the updating means may be any module or any apparatus configured to perform the functions recited by the updating means.

The examples above describe aspects implemented in an LTE/-A system. However, the scope of the disclosure is not so limited. Various aspects may be adapted for use with other communication systems, such as those that employ any of a variety of communication protocols including, but not limited to, CDMA systems, TDMA systems, FDMA systems, and OFDMA systems.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
selecting between a delayed channel estimation and an undelayed channel estimation for channel state information (CSI) computing, the selecting being based on a signal metric; and
computing the CSI based on a selected channel estimation.

2. The method of claim 1, in which the signal metric comprises presence of one or more of a non-colliding reference signal interferer, an interferer power level, a channel estimation quality indication, and/or a Doppler level observed at a user equipment (UE).

3. The method of claim 1, in which the signal metric indicates presence or absence of a non-colliding reference signal interferer during a second reference subframe, and the selecting further comprises:
selecting a delayed channel estimate for computing the CSI, where the delayed channel estimate is based on a first reference subframe, when the signal metric indicates the presence of the non-colliding reference signal interferer during the second reference subframe; and
selecting an undelayed channel estimate for computing the CSI, where the undelayed channel estimate is based on the second reference subframe, when the signal metric indicates the absence of the non-colliding reference signal interferer during the second reference subframe.

4. The method of claim 3, in which a subframe index of the first reference subframe is N−4−k, and the subframe index of the second reference subframe is N−4, where N is the subframe index on which the CSI is to be transmitted on an uplink and k is an integer greater than or equal to one.

5. The method of claim 1, in which selecting further comprises:
determining a power level of a non-colliding reference signal interferer when the signal metric indicates presence of the non-colliding reference signal interferer during a second reference subframe;
selecting a delayed channel estimate when the power level of the non-colliding reference signal interferer during the second reference subframe is greater than or equal to a predetermined power level; and
selecting an undelayed channel estimate when the power level of the non-colliding reference signal interferer during the second reference subframe is less than the predetermined power level.

6. The method of claim 1, in which the signal metric indicates a channel estimation quality.

7. The method of claim 1, in which the signal metric indicates a Doppler level.

8. A method of wireless communication, comprising:
maintaining a record of channel frequency responses (CFRs) for computing channel state information (CSI); and
determining, for each subband, whether a criteria is met;
updating the record of CFRs over each subband that meets the criteria; and
computing the CSI based on the record of CFRs.

9. The method of claim 8, in which the criteria is met when a channel estimation quality over the subband is above or below a threshold.

10. The method of claim 9, further comprising determining the threshold based at least in part on a Doppler level.

11. The method of claim 8, in which the criteria is met when a signal to interference plus noise ratio (SINR) over a subband exceeds a threshold, and/or a mean square error of a current channel estimation is lower than the threshold.

12. The method of claim 8, in which a plurality of subbands comprise a system bandwidth, each of the subbands comprising a subset of frequency tones.

13. An apparatus operable for wireless communication, comprising:
a memory; and
at least one processor coupled to the memory, the at least one processor being configured:
to select between a delayed channel estimation and an undelayed channel estimation for channel state information (CSI) computing, the selecting being based on a signal metric; and
to compute the CSI based on a selected channel estimation.

14. The apparatus of claim 13, in which the signal metric comprises presence of one or more of a non-colliding reference signal interferer, an interferer power level, a channel estimation quality indication, and/or a Doppler level observed at a user equipment (UE).

15. The apparatus of claim 13, in which the signal metric indicates presence or absence of a non-colliding reference signal interferer during a second reference subframe, and the at least one processor is further configured to select by:
selecting a delayed channel estimate for computing the CSI, where the delayed channel estimate is based on a first reference subframe, when the signal metric indicates the presence of the non-colliding reference signal interferer during the second reference subframe; and
selecting an undelayed channel estimate for computing the CSI, where the undelayed channel estimate is based on the second reference subframe, when the signal metric indicates the absence of the non-colliding reference signal interferer during the second reference subframe.

16. The apparatus of claim 15, in which a subframe index of the first reference subframe is N−4−k, and the subframe index of the second reference subframe is N−4, where N is the subframe index on which the CSI is to be transmitted on an uplink and k is an integer greater than or equal to one.

17. The apparatus of claim 13, in which the at least one processor is further configured to select by:
determining a power level of a non-colliding reference signal interferer when the signal metric indicates presence of the non-colliding reference signal interferer during a second reference subframe;
selecting a delayed channel estimate when the power level of the non-colliding reference signal interferer during the second reference subframe is greater than or equal to a predetermined power level; and
selecting an undelayed channel estimate when the power level of the non-colliding reference signal interferer during the second reference subframe is less than the predetermined power level.

18. The apparatus of claim 13, in which the signal metric indicates a channel estimation quality.

19. The apparatus of claim 13, in which the signal metric indicates a Doppler level.

20. An apparatus operable for wireless communication, comprising:
means for selecting between a delayed channel estimation and an undelayed channel estimation for channel state information (CSI) computing, the selecting being based on a signal metric; and
means for computing the CSI based on a selected channel estimation.

21. A computer program product operable for wireless communication, the computer program product comprising:
a computer-readable medium having non-transitory program code recorded thereon, the program code comprising:
program code to select between a delayed channel estimation and an undelayed channel estimation for channel state information (CSI) computing, the selecting being based on a signal metric; and
program code to compute the CSI based on a selected channel estimation.

22. An apparatus operable for wireless communication, comprising:
a memory; and
at least one processor coupled to the memory, the at least one processor being configured:
to maintain a record of channel frequency responses (CFRs) for computing channel state information (CSI); and
to determine, for each subband, whether a criteria is met;
to update the record of CFRs over each subband that meet the criteria; and
to compute the CSI based on the record of CFRs.

23. The apparatus of claim 22, in which the criteria comprises a channel estimation quality over the subband being above or below a threshold.

24. The apparatus of claim 23, in which the at least one processor is further to determine the threshold based at least in part on a Doppler level.

25. The apparatus of claim 22, in which the criteria is met when a signal to interference plus noise ratio (SINR) over a subband exceeds a threshold, and/or a mean square error of a current channel estimation is lower than the threshold.

26. An apparatus operable for wireless communication, comprising:
means for maintaining a record of channel frequency responses (CFRs) for computing channel state information (CSI); and
means for determining, for each subband, whether a criteria is met;
means for updating the record of CFRs over each subband that meet the criteria; and
means for computing the CSI based on the record of CFRs.

27. A computer program product operable for wireless communication, the computer program product comprising:
a computer-readable medium having non-transitory program code recorded thereon, the program code comprising:
program code to maintain a record of channel frequency responses (CFRs) for computing channel state information (CSI); and
program code to determine, for each subband, whether a criteria is met;
program code to update the record of CFRs over each subband that meet the criteria; and
program code to compute the CSI based on the record of CFRs.
